(19) United States
(12) Patent Application Publication
(10) Pub. No.: US 2026/0366951 A1
(43) Pub. Date: Nov. 19, 2026

(54) LEAK DETECTION BY CAPILLARY ACTION

(71) Applicant: Nvidia Corporation, Santa Clara, CA (US)

(72) Inventors: Vijaykumar Krithivasan, Union City, CA (US); Fraser Syme, Rochester, MN (US); Ryan Albright, Beaverton, OR (US); Richard Burton Finch, Largo, FL (US); Sreekanth Kurra, Bothell, WA (US)

(21) Appl. No.: 19/206,979

(22) Filed: May 13, 2025

(51) Int. Cl. G01M 3/40; G01M 3/18

(52) U.S. Cl. CPC G01M 3/40; G01M 3/182

(57) ABSTRACT

An apparatus includes capillary tubes and a sensing circuit. The apparatus may be placed at a potential leak point in a data center or other environment where liquid is transported. When liquid leaks near the capillary tubes, the capillary tubes transport the liquid by capillary action to the sensing circuit. The sensing circuit may generate a signal indicating the presence of a leak.

### BACKGROUND

Various systems rely on transporting liquid through tubing, such as hydraulic tubing, cooling systems, or cooling loops to, e.g., circulate a liquid among equipment. In some environments, cooling loops often interface with inlet loops that are fixed within racks or hardware units. The interface between the cooling loop and the inlet loop, such as a connection point, may be a potential site of liquid leakage. Even minor leaks in this area may cause hardware damage, short circuits, or lead to costly downtime, making early leak detection and important consideration in the design of such systems.

Some conventional sensors often require a relatively large amount of liquid to accumulate before they generate a signal. Often, this signal is generated after significant damage to hardware has already occurred. Furthermore, such conventional sensors may not be able to pinpoint the exact location of a leak, especially in complex environments with multiple connection points. This can make troubleshooting and repair time-consuming.

### BRIEF DESCRIPTION OF THE DRAWINGS

Various embodiments in accordance with the present disclosure will be described with reference to the drawings, in which:

FIG. 1A illustrates a system including an apparatus with capillary tubes, a sensing circuit, and a controller, according to example embodiments;

FIG. 1B illustrates an apparatus with capillary tubes and a sensing circuit, according to example embodiments;

FIG. 1C illustrates a system for generating an electrical signal responsive to a liquid leak by transporting the liquid through capillary tubes to a sensing circuit, according to example embodiments;

FIG. 2 illustrates a system for generating an alert responsive to an electrical signal from an apparatus including capillary tubes and a sensing circuit, according to example embodiments;

FIGS. 3A-3D illustrate an apparatus integrated into the body of a cylinder to be placed at a connection point between a cooling tube and a quick disconnect (QD) device, according to example embodiments;

FIGS. 4A-4B illustrate an apparatus comprising a flexible cloth or material, according to example embodiments;

FIG. 5A illustrates a process for transmitting an electrical signal based on a detected leak, according to example embodiments;

FIG. 5B illustrates a process for generating an alert corresponding to a leak, according to example embodiments;

FIG. 5C illustrates a process for draining the capillary tubes and moving an apparatus to a separate connection point, according to example embodiments;

FIG. 6 illustrates components of a distributed system that may be utilized in a data center, according to example embodiments;

FIG. 7 illustrates an example data center system, according to example embodiments;

FIG. 8 illustrates an example computing environment, according to example embodiments;

FIG. 9 illustrates a computer system, according to example embodiments;

FIG. 10 illustrates a computing system, according to example embodiments; and

FIG. 11 illustrates a data center with a cooling system, according to example embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Conventional leak detection technologies such as rope sensors and capacitive sensors have notable limitations that can compromise their effectiveness in critical environments. Rope sensors typically rely on moisture sensitive material laid along the floor or near fluid carrying components. They may trigger an alert when a significant amount of liquid saturates the rope. However, this approach often results in delayed detection as it requires fluid accumulation over a broader area before activation.. Capacitive sensors, on the other hand, detect changes in dielectric properties when a liquid is present near the sensor's field. While more localized, these capacitive sensors can be unreliable in variable environmental conditions or be used with different fluid types since variations and conductivity or dielectric constants can impact accuracy. Furthermore, rope sensors can be prone to false alarms due to moisture or condensation, especially in humid environments, while capacitive sensors may be affected by environmental factors or variations in liquid conductivity. Both technologies often lack the precision needed to pinpoint the exact location of a leak, particularly in systems with numerous connection points, which can complicate maintenance and delay response times. Furthermore, the time it takes for these sensors to detect a leak and trigger an alert can be too slow for systems requiring rapid response to prevent damage.

This disclosure is directed generally to an apparatus which uses capillary tube(s) to transport liquid to a sensing circuit. The apparatus may be placed near a common leak point, e.g., near a quick disconnect point. When a leak occurs, the capillary tube(s) may transport some of the leaked liquid to a sensing circuit. The sensing circuit produces a signal based on an electrical charge (e.g., a change in capacitance, resistance, or conductivity) and transmits the signal to a controller. The signal may indicate the presence of the leak as well as a location of the leak. In one embodiment, the capillary tubes are physically integrated into a fitting, such as a male fitting or a female fitting, between a quick disconnect and a manifold. In other embodiments, the capillary tube may be integrated into a fabric or flexible material which may be wrapped around, fitting the sensor around the quick disconnect, or otherwise placed near a common leak point. By utilizing a capillary tube that encircles the quick disconnect (QD), even the smallest leak will be drawn into the tube via capillary action. This allows for very early detection of leaks, potentially even single drips, before they cause significant damage or system failure. The capillary tube guides the liquid directly to the conductivity sensor, pinpointing the leak's location. This eliminates the ambiguity of rope or capacitive sensors and allows for targeted intervention. The capillary tube and snap-fit design can be a solid piece that can be screwed on or snapped on to be easily integrated with existing QD systems without major modifications.

In some example embodiments, when the measured electrical charge reaches a predefined threshold, the controller may trigger an alert such as activating a light emitting diode (LED) or an alarm buzzer.

The snap-fit design ensures consistent sensor placement and contact, improving reliability and reducing variations in readings. The snap-fit mechanism allows for quick installation and replacement of the sensor unit, simplifying maintenance (e.g., easy to install and replace sensor units) and minimizing downtime. The system is adaptable to various QD systems. In some example embodiments in which the apparatus is a solid cylindrical component, a snap-fit design can be implemented by integrating flexible latching features or molded retention tabs directly into the body of a solid piece. As a nonlimiting example, the apparatus could be a ring-like or sleeve-like structure designed to snap onto the end of an inlet or cooling loop, similar to the structure and operation of a QD collar might operate. The interior of this solid cylindrical apparatus may include detent features, ridges or spring loaded tabs which engage with corresponding grooves or notches on the mating end of the tube or inlet.

While some example embodiments are described with reference to data centers and liquid cooling infrastructures, other example embodiments may be broadly applicable to any environment where fluid carrying lines are used and leak detection is critical. As a nonlimiting example, the systems and apparatus described herein could be adapted for use in agricultural or construction machinery such as tractors or excavators where hydraulic lines are under constant pressure and leaks can lead to performance issues or safety hazards. Similarly, the apparatus described herein may be used in industrial manufacturing equipment, chemical processing facilities, heating ventilation and air conditioning (HVAC) systems, residential plumbing, or indeed any scenario in which fluid is transported through tubing or piping and early leak detection can prevent costly damage or downtime. The passive, power-free nature of the capillary tubes combined with the flexible or modular design makes this apparatus highly versatile, allowing it to conform to a wide range of use cases beyond just the high tech environments initially described.

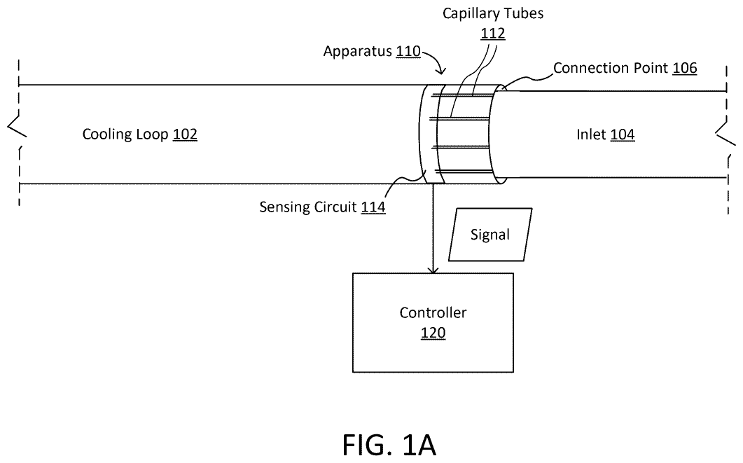

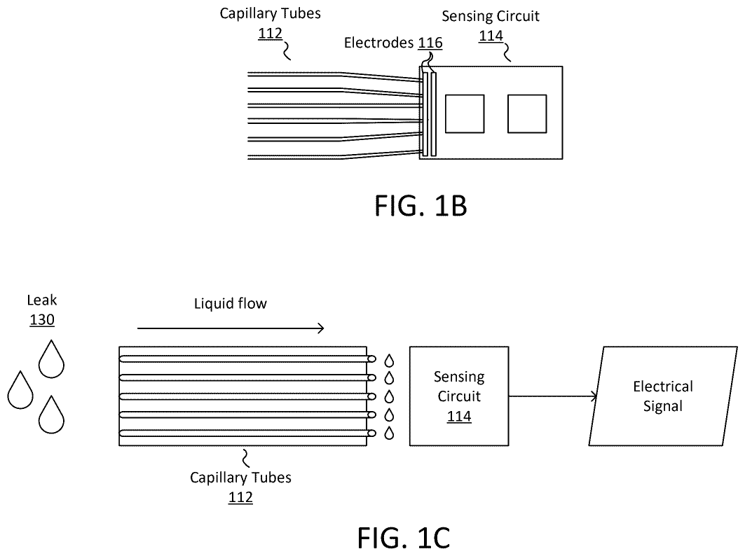

In FIG. 1A, a cooling loop 102 may be connected to an inlet 104 at a connection point 106. This connection point 106 may be formed using a variety of coupling methods including threaded male-to-female fittings, QD mechanisms, or any other conventional joining approaches. Regardless of the coupling method used, this connection point 106 is susceptible to leaks due to wear, installation errors, or material degradation over time. To address potential leaks formed at the connection point 106, a leak-sensing apparatus 110 is deployed at or proximate the connection point 106, either by being physically integrated into the body of the cooling loop 102 or the inlet 104, or by being applied externally in the form of a flexible wrap, such as a fabric, around the connection point 106. The leak-sensing apparatus 110 is configured to be removably attached to the connection point 106 between the cooling loop 102 and the inlet 104. The sensor exploits the conductive properties of coolant which contains ingredients like PG25 or PG45 that make it electrically conductive to detect leaks at the weakest link, where connections between the manifold and the distribution occur specifically at the quick disconnect.

The apparatus 110 serves as a passive, low-power leak detection system which relies on capillary action for liquid transport. The apparatus 110 may include one or more capillary tubes 112 positioned so that leaked liquid from the connection point 106 is quickly drawn into the capillary tubes 112. The capillary tubes 112 may be arranged to form a capillary tube array. The dimensions of these tubes are estimated to exploit capillary action effectively, allowing even a small amount of coolant to be drawn in. This action is facilitated by a group or array of thin straw-like tubes around the quick disconnect joint. Capillary action may refer to the natural movement of liquid through narrow tubes without the need for external power or pressure. This capillary action may occur because the adhesive forces between the liquid and the inner surface of the tube are stronger than the cohesive forces within the liquid itself. In example embodiments, a capillary tube 112 may have in inner diameter of approximately 0.3 mm to 1.0 mm and a length ranging from 50 mm to 300 mm, depending on the size of the apparatus 110 and the distance between the leak-prone area and the sensing circuit 114. The outer diameters of the capillary tubes 112 may vary based on the thickness of the capillary tubes 112 and the materials used. In other example embodiments, other measurements and dimensions may be used. The capillary tubes 112 may use capillary action to transport the liquid without the need for mechanical pumps or electrical power, making the apparatus 110 both energy efficient and highly reliable (e.g. less susceptible to false alarms and environmental factors). Because the capillary tubes 112 may be embedded or woven into different structural forms, the apparatus 110 is highly versatile and may be adapted for both rigid and flexible implementations.

Once liquid is transported through the capillary tubes 112, the liquid reaches a sensing circuit 114 which is configured to detect the presence of the liquid. The sensing circuit 114 may use conductivity, resistivity, or any other electrical property which changes in the presence of the liquid. The conductivity sensor with the RC circuit provides a direct measurement of the liquid's presence. This eliminates reliance on indirect measurements and enables faster response times than rope sensors or capacitive sensors that require significant liquid accumulation for detection. It also reduces false alarms by providing a distinct signal when liquid bridges the electrodes.

Upon detection, the sensing circuit 114 generates a signal which is transmitted to a controller 120. This controller 120 may be integrated into a broader system management framework and may log the occurrence of the leak, alert personnel, or even trigger an automated shutdown or containment protocols to protect surrounding equipment. The integration of the apparatus 110 onto one or more connection points 106 enhances the resilience and maintainability of liquid cooled data center systems by positioning the apparatus 110 at the most likely failure points. Leaks may be detected early without introducing significant complexity or power consumption.

The capillary tubes 112 serve as the liquid transport mechanism within the apparatus 110, enabling passive movement of leaked liquid from a potential leak site to the sensing circuit 114. The capillary tubes 112 may be physically integrated or mounted along the longitudinal axis of the cooling loop 102 or inlet 104, running parallel to the cylindrical surface of the tubing. In other embodiments, one of the two ends of the capillary tubes may be radially disposed around the connection point 106. This orientation maintains a low-profile design and allows for efficient coverage of the connection point 106 where leaks are most likely to occur. The apparatus 110 may include any number of capillary tubes 112, including as few as one capillary tube to as many as any number of capillary tubes depending on the size of the apparatus 110 and the level of sensitivity required for leak detection. To achieve capillary action, the internal diameter of each of the capillary tubes 112 may be small enough to enable the liquid to rise or travel due to surface tension and adhesive forces without the aid of external pumps or power sources. The capillary tubes 112 may be manufactured from a variety of materials, including glass, plastic, or metal, as long as they support the capillary effect and are compatible with the type of liquid being used. Generally, each capillary tube 112 features two open ends. One end may be positioned near the external surface of the apparatus 110 proximate to the connection point 106, and the other end terminates near or within the sensing circuit 114. Thus, the capillary tubes 112 ensure that any liquid which is leaked at the connection point 106 is quickly transported through the capillary tubes 112 and delivered to the sensing circuit 114. In some example embodiments, the individual capillary tubes 112 may be replaceable. If a capillary tube 112 becomes clogged or damaged, it may be swapped out without needing to replace the entire apparatus 110, supporting long term maintainability and serviceability in operational environments.

The sensing circuit 114 may be designed to detect the presence of leaked liquid delivered via the capillary tubes 112. The sensing circuit 114 includes at least two electrodes positioned such that a liquid bridging the at least two electrodes will alter an electrical property such as resistance or conductivity. In the presence of the liquid, the sensing circuit 114 registers a measurable change in electrical behavior. This electrical change may be interpreted as a signal that may be processed locally or transmitted to an external controller 120. The sensing circuit 114 may also incorporate additional electronic components such as amplifiers, filters, or analog to digital converters to condition and refine the signal before it is sent onward. The sensing circuit 114 may be a flexible electronic assembly capable of physically conforming to curved surfaces like tubing or being integrated into mesh or fabric materials. This flexibility enables the sensing circuit 114 to be used in a variety of physical configurations, whether embedded directly into the structure of a cooling loop 102 or inlet 104, or integrated onto a textile wrap. The sensing circuit 114 may communicate with the external controller 120 via either a wired connection or a wireless connection. This could involve transmitting data to a server management device, such as an hardware management console (HMC) or baseboard management controller (BMC), or even transmitting data outside the tray. The sensor could transmit telemetry data continuously or at set intervals. The continuous telemetry could be characterized and used to predict potential leaks based on historical data.

In some example embodiments, the sensing circuit 114 may be configured not only to detect the presence of liquid from the leak, but also to collect and transmit telemetry data over time. This telemetry data could include parameters such as the frequency of minor liquid detections, the duration of wet conditions, the volume or conductivity of the detected liquid, and environmental conditions such as temperature or humidity. By regularly transmitting this data to the controller 120, the controller 120 may build a historical profile of liquid behavior and leak tendencies at each monitored connection point 106 over time patterns and the telemetry, such as repeated minor leaks at the same location or prolonged periods of moisture, may be flagged as precursors to larger failures. The controller 120 or connected analytics platform may then use machine learning or rule based algorithms to evaluate the telemetry data alongside historical records to predict potential leak events before they occur. In example embodiments, if a particular connection point 106 shows a recurring pattern of leaks that resolve and reappear, the controller 120 may automatically generate a predictive alert indicating that maintenance or inspection is recommended.

When the sensing circuit 114 detects the presence of a liquid, the sensing circuit 114 transmits a signal to the controller 120. This signal may not only confirm the existence of a leak, but may also provide information about the precise location of the leak within a data center compute tray or switch tray. In some example embodiments, each sensing circuit 114 may be assigned a unique identifier or an address which may be hard coded into the sensing circuit 114's onboard memory or assigned during system configuration. When the controller 120 receives the signal from the sensing circuit 114, the controller 120 may associate that signal with a specific connection point 106, server rack, or physical area in a data center. Based on this signal, the controller 120 may be able to create an alert indicating both the presence of a leak and the location of the leak, allowing operators to perform a rapid targeted response to the leaked liquid and minimize the risk of damage or downtime. In some embodiments, each sensing circuit 114 may be connected to a dedicated input on the controller 120, inherently tying a physical input port to a specific location. In a wireless implementation, each sensing circuit 114 could periodically broadcast its unique ID along with its status signal, allowing the controller 120 to correlate a unique ID with a known location and a facility database. In other embodiments, the sensing circuit 114 may include programmable logic on the sensing circuit 114 itself, enabling additional metadata to be transmitted such as timestamp, leak severity, or environmental data.

In example embodiments, the controller 120 may include a processor (e.g., a central processing unit (CPU) or graphics processing unit (GPU)), data processing units (DPUs), quantum processing units (QPUs), a plurality of parallel processing units (PPUs), and application-specific integrated circuits (ASICs) memory module, or power supply. QPUs configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

FIG. 1B illustrates the capillary tubes 112 and the sensing circuit 114. The capillary tubes 112 may each include two ends: one end may be positioned near a potential leak site, such as a connection point between a cooling loop and an inlet; and the opposite end may terminate at or near a pair of electrodes 116 located on the sensing circuit 114. When liquid enters a capillary tube 112 at the leak point, the capillary tube 112 passively transports the liquid to the electrodes 116 on the sensing circuit 114 through capillary action. Upon reaching the electrodes 116, the liquid may bridge the gap between the electrodes 116, resulting in a measurable change in electrical conductivity or resistivity. The liquid in the capillary tube may create a conductive bridge between the two electrodes of the conductivity sensor, completing the electrical circuit. The sensing circuit may use this measurable change a signal indicating the presence and location of a leak within the data center. The change in conductivity alters the resistance of the RC circuit, causing a change in the voltage across the capacitor. This voltage change is measured by the microcontroller.

As illustrated in FIG. 1B, the sensing circuit 114 is represented as a simple rectangular block for clarity. However, in other embodiments, the sensing circuit 114 could take on a variety of forms depending on the application. In some embodiments, the sensing circuit 114 may be curved or segmented to conform to the inner surface of a cylinder. The sensing circuit 114 may also be integrated into a flexible material such as a fabric mesh, allowing it to be wrapped around an irregular surface. In example embodiments, the sensing circuit 114 may include onboard memory and a processor and enabling it to store calibration data, generate signals, and execute simple instructions before sending data to the controller 120.

FIG. 1C illustrates the generation of an electrical signal in response to a presence of a leak. FIG. 1C illustrates the presence of a leak 130 which may consist of cooling liquid, moisture from condensation, or any other form of unwanted liquid in an environment. This leaked liquid 130 is positioned near the open ends of one or more capillary tubes 112. Due to capillary action within the capillary tubes 112, the liquid from the leak 130 is drawn into the capillary tubes 112 without the need for any external power or mechanical pumping, enabling a passive and reliable means of liquid transport. The capillary tubes 112 act as conduits by channeling the liquid towards the sensing circuit 114. As the liquid moves through the capillary tubes 112, the liquid eventually reaches the opposite end of the capillary tubes 112, which is disposed at or near the sensing circuit 114. The liquid may be deposited in the area between or around the sensing circuit 114's electrodes. The presence of the liquid alters the electrical properties of the sensing circuit 114 and causes the generation of the electrical signal.

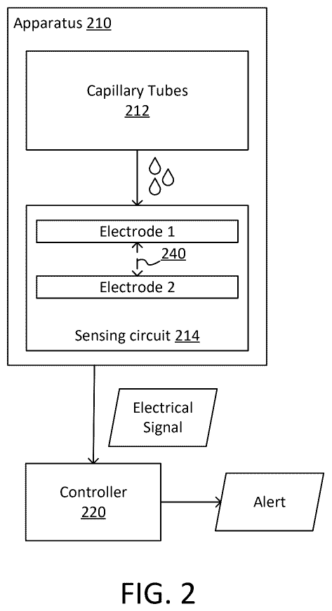

FIG. 2 illustrates the interaction between an apparatus 210 and a controller 220. The apparatus 210 comprises one or more capillary tubes 212 and a sensing circuit 214. The sensing circuit 214 includes at least two electrodes: Electrode 1 and Electrode 2. It is understood that additional electrodes may be included in other example embodiments to support more complex detection or redundancy. The capillary tubes 212 are responsible for transporting liquid from a potential leak site to the sensing circuit 214. Once the liquid reaches the electrodes, the liquid is deposited at or near Electrode 1 and Electrode 2, potentially bridging the gap between them and altering the electrical characteristics (e.g., conductivity or resistivity) of Electrode 1 and Electrode 2. Thus, an electrical connection 240 may be established between Electrode 1 and Electrode 2, which triggers the sensing circuit 214 to generate a signal. The sensing circuit 214 may transmit the signal to the controller 220 via a wired or wireless connection. The nature of this signal transmission may vary. In some embodiments, electrical signals are sent continuously or at regular intervals, while in other embodiments, the sensing circuit 214 only transmits a signal in response to detecting a leak. Alternatively, the sensing circuit 214 and the controller 220 may be synchronized to communicate on a timed schedule, providing periodic updates on leak status and location. Once a signal indicating a leak is received from the sensing circuit 214, the controller 220 may determine the presence and potentially the location of the leak based on the identity or address of the transmitting sensing circuit 214. In some example embodiments, the controller 220 may determine 522 whether the received signal exceeds a predefined threshold. In some example embodiments, the threshold may be a specific voltage level which represents the minimum conductivity needed to confirm the presence of a liquid. In other example embodiments, the signal may represent a time-based value, e.g., how long the electrodes have been bridged by a conductive liquid indicating a proportional reading of the amount of liquid detected based on the intensity of the signal. In other example embodiments a controller 220 might be set to trigger an alert if the conductivity remains above 1.5 micro siemens for more than three seconds, indicating a sustained leak rather than a brief splash or minor condensation event.

Upon determining, based on the signal, that a leak has occurred, the controller 220 may trigger a variety of events. These may include visual cues (e.g., activating an LED indicator, audible warnings (e.g., sounding a buzzer), or digital alerts (e.g., sending a message or notification to an administrator device or user device) over a wired or wireless connection.

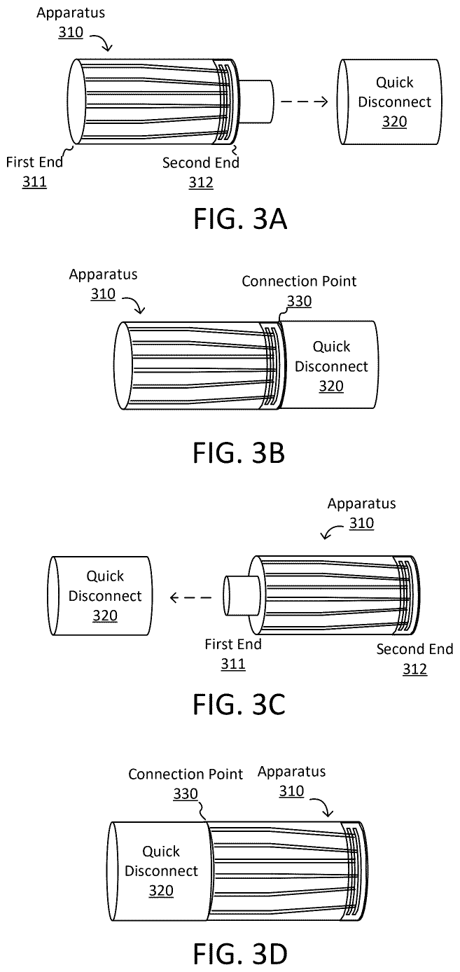

FIGS. 3A and 3B depict various configurations in which the apparatus 310 may be integrated into or mounted on a cylindrical structure, such as a pipe, cooling loop segment, or other tubular conduit. In example embodiments, the apparatus 310 may be embedded directly into the body of the cylinder, either on the outer surface or along the interior wall of the inner diameter of the cylinder. Alternatively, the apparatus 310 may be modular and removably attached to the surface of the cylinder, allowing for flexible installation and maintenance. FIGS. 3A and 3B demonstrate how the apparatus 310 may become part of an attachment to the structural components of a cooling or liquid transport system. The apparatus 310 may be configured to removably attach along a cylinder which has a first end 311 and a second end 312. A plurality of capillary tubes may be positioned to run longitudinally (e.g., parallel to the central axis of the cylinder) from the first end 311 to the second end 312. The sensing circuit may be positioned at or near the second end 312, which corresponds to a connection point 330 between the cylinder and a quick disconnect 320. This configuration allows leaked liquid which originates near the first end 311 to be passively transported through the capillary tubes toward the sensing circuit at the second end 312 located near the connection point 330. Once the liquid reaches the sensing circuit, the sensing circuit generates a signal which indicates the presence of the leaked liquid. In some embodiments, because the sensing circuit is already located near the connection point 330, which is a common area for leaks to occur, and may directly detect liquid at that location even without relying on capillary transport. This allows for a dual-functionality capillary assisted detection for leaks originating further from the sensing circuit and direct detection for leaks which appear immediately at or around the connection point 330 preventing extensive damage. This allows users to make early detection of leaks across the length of the cylinder and at particularly high-risk connection points 330.

FIGS. 3C and 3D illustrate an example of the apparatus 310 in which the connection point 330 between the tube and the quick disconnect 320 is located at the first end 311 of the cylindrical structure rather than at the second end 312 (as illustrated in FIGS. 3A and 3B). In this example embodiment, the sensing circuit remains positioned at or near the second end 312 of the cylinder, while the open intake ends of the capillary tubes are located at or proximate the connection point 330 at the first end 311. This allows any liquid which leaks at the connection point 330 to enter the capillary tubes and be transported longitudinally along the cylinder via capillary action to the sensing circuit at the second end 312. This orientation maintains the same fundamental principle of passive liquid transport, but adapts it to a different structural layout than illustrated in FIGS. 3A and 3B. By placing the open ends of the capillary tubes near the connection point 330 at the first end 311, the apparatus 310 ensures that any leaks occurring at the interface between the tube and the quick disconnect 320 will be promptly captured and channeled toward the sensing circuit at the second end 312. Once the liquid reaches the second end 312 and interacts with the electrodes of the sensing circuit, the sensing circuit generates and transmits an electrical signal to the control indicating the presence and location of the leaked liquid.

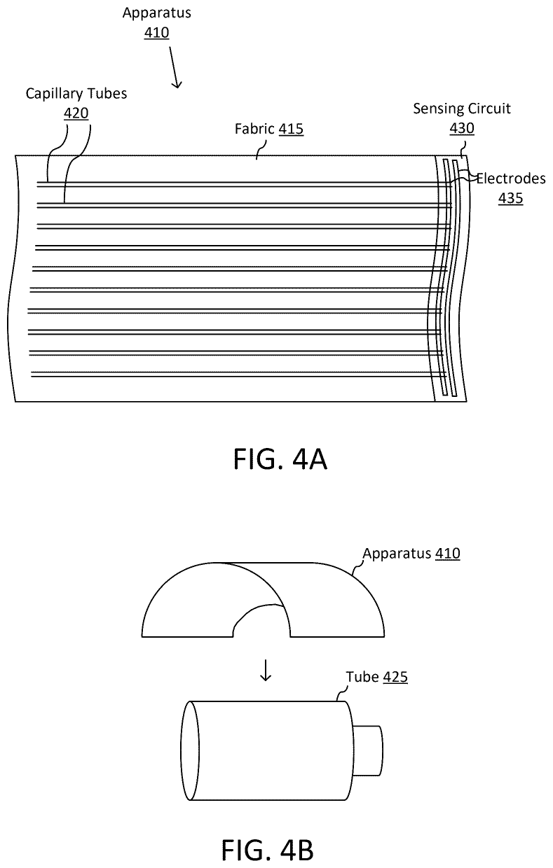

FIGS. 4A and 4B introduce a flexible and adaptable embodiment of the leak detection system, wherein the apparatus 410 is not embedded in a rigid structure but is instead integrated into a soft flexible material such as the fabric 415. The fabric 415 provides modularity and reusability, thereby allowing the apparatus 410 to be deployed across various liquid connection points without permanent installation. The fabric 415 may be composed of any suitable flexible material such as woven polyester, nylon mesh, silicone coated textiles, or any other materials which are suitable for resistance to liquid absorption and their ability to conform to curved surfaces like tubing or connector houses. In example embodiments, capillary tubes 420 are integrated directly into the fabric 415. In example embodiments, the capillary tubes 420 may be adhered to the surface of the fabric 415 using adhesives, embedded within specially designed sleeves on the fabric 415, or even woven into the fabric 415 itself. The capillary tubes 420 may passively transport liquid from a potential leak site to the sensing circuit 430 via capillary action. Similarly, the sensing circuit 430, which includes electrodes 435, may be affixed to or embedded within the fabric using adhesives, mechanical enclosures, or sewn in flexible circuit carriers.

FIG. 4A shows the apparatus 410 in a flat configuration, highlighting how the capillary tubes 420, sensing circuit 430, and electrodes 435 are distributed across the surface of the fabric 415. This flat configuration allows the apparatus 410 to be stored easily, applied quickly, and adapted to different connection geometries. The flexibility of the fabric 415 makes it highly compatible with a wide range of tube diameters and connection styles, particularly in environments like data centers where piping configurations may vary.

As illustrated in FIG. 4B, the fabric 415 may be wrapped around a tube 425, such as a tube 425 acting as a junction between two cooling lines or a quick disconnect fitting, so that the capillary tubes 420 are positioned proximate a connection point. Once in place, any leaked liquid may be drawn into the capillary tubes 420 and transported to the sensing circuit 430, which then detects the presence of the leaked liquid and generates an electrical signal.

To enhance reusability and practicality, the fabric 415 may be secured using any number of common fastening methods, including snaps, hook and loop fasteners, elastic loops, buttons, or ties. This allows the fabric 415 to be removed easily from one connection and reuse at another connection, or replaced entirely.

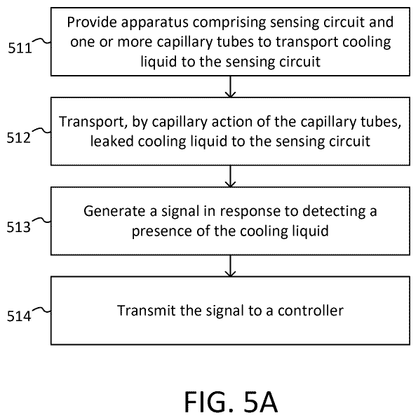

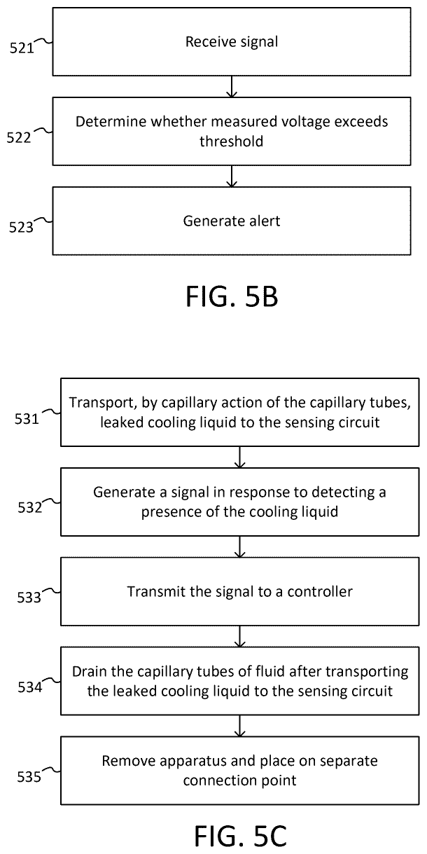

FIG. 5A illustrates a process for detecting the presence of a leak using capillary action. The steps and actions in FIG. 5A may be taken in a different order than what is illustrated, and the steps and actions may be performed a greater or fewer number of times than what is described. An apparatus may be provided 511, wherein the apparatus includes a sensing circuit and one or more capillary tubes at or near a liquid connection point. This apparatus may be implemented in a variety of configurations, such as integrating the apparatus into the body of a tube, wrapping a flexible fabric embodiment around a connection point, or mounting the apparatus along the interior or exterior surface of a cylinder. The apparatus may be positioned so that the open ends of the capillary tubes are located near high-risk areas where leaks may occur, such as quick disconnect fittings or junctions in a cooling loop. Once the apparatus is in place, the capillary tubes may transport 512 the leaked liquid through the capillary tubes to the sensing circuit. This may occur via capillary action, which does not require external power and may be influenced by the diameter and material of the capillary tubes, which may be constructed from suitable materials including, without limitation, plastic, glass or metal. In example embodiments, a leak occurring at a connection point on a server rack's cooling loop may cause leaked liquid to enter the capillary tubes which are aligned longitudinally along the tubing. The leaked liquid may then be drawn through the tubes to the sensing circuit which includes at least two electrodes. When the liquid reaches the circuit, it bridges the electrodes or otherwise alters the surrounding conductivity, thereby causing the sensing circuit to generate 513 a signal in response to detecting a presence of the leaked liquid. The sensing circuit may then transmit 514 this signal to a controller. The sensing circuit may transmit the signal to the controller over a wired or wireless connection. The signal may indicate the presence of a liquid or, additionally, metadata or identification data to allow the controller to determine the specific location of the leak. In example embodiments, in a data center, each sensing circuit may be associated with a specific rack or pipe junction, allowing the controller to precisely identify the fault area. Upon receiving the signal, the controller may initiate alerts such as activating an LED, sounding a buzzer, or sending a message to an administrator device or user device.

FIG. 5B illustrates a process for determining whether a leak exceeds a threshold before issuing an alert. The steps and actions in FIG. 5B may be taken in a different order than what is illustrated, and the steps and actions may be performed a greater or fewer number of times than what is described. A controller may receive 521 a signal from a sensing circuit over a wireless or wired connection. This signal originates from the sensing circuit's electrodes, which detect a change in conductivity, resistance, or voltage. The controller may determine 522 whether the received signal exceeds a predefined threshold. This threshold may take several forms. In some example embodiments, the threshold may be a specific voltage level which represents the minimum conductivity needed to confirm the presence of a liquid. In other example embodiments, the threshold may represent a time-based value, e.g., how long the electrodes have been bridged by a conductive liquid indicating a proportional reading of the amount of liquid detected based on the intensity of the signal. In other example embodiments, in a data center environment where sensitive hardware must be protected, a controller might be set to trigger an alert if the conductivity remains above 1.5 micro siemens for more than three seconds, indicating a sustained leak rather than a brief splash or minor condensation event.

The controller may generate 523 an alert based on this determination. In example embodiments, the alert could be a visual alert such as a flashing LED located near the affected connection point; an auditory alert such as sounding a buzzer; or a digital alert such as sending a push notification, e-mail, or text to a user's device or an administrator's device. In some variations, the alert may also include metadata such as the ID of the sensing circuit or its assigned location, allowing the user to pinpoint exactly the area affected.

FIG. 5C illustrates a process disclosing the modularity and reusability of the leak detection apparatuses discussed herein. The steps and actions in FIG. 5C may be taken in a different order than what is illustrated, and the steps and actions may be performed a greater or fewer number of times than what is described. The apparatus may transport 531, by capillary action at the capillary tubes, leaked cooling liquid to a sensing circuit in the apparatus. Once the liquid reaches the sensing circuit, the apparatus may generate 532 a signal in response to detecting a presence of the cooling liquid. The sensing circuit may transmit 533 the signal to a controller.

At some point after this detection event, a user may decide to remove the apparatus from its current location and redeploy it to monitor another connection point. In some embodiments, the user may desire this because the original leak has been resolved and the area no longer needs monitoring, or the apparatus is being rotated as part of routine maintenance cycles. In data centers or industrial systems where spare equipment is limited, being able to move the same apparatus to another high-risk area without replacing the entire unit reduces costs and improves operational efficiency. Before relocation, the capillary tubes may be drained 534 of any residual liquid. Draining the tubes ensures accurate readings at the new location and prevents contamination or false positives. In example embodiments, the user could use air pumps, vacuum syringes, or squeeze bulbs to draw out the liquid from one end of the capillary tubes. In a flexible fabric embodiment, simply unwrapping the fabric and lightly pressing or rolling it from one end to another may expel the liquid. In embodiments in which the apparatus is integrated into a tubing, the tube may include a drainage valve or removable section to allow manual cleaning or evaporation of the liquid between uses. The apparatus may be removed 535 (e.g., by a user or administrator) and placed on a separate connection point. In example embodiments where the apparatus is a fabric-based design, this removal might include unclipping, unstrapping, or unstrapping the fabric from one pipe and securing it around a new one using the same connection elements. In embodiments where the apparatus is integrated into a tube, the apparatus might be detached from a modular sleeve or bracket and reinstalled in another section of piping. For example, the tubing which has the apparatus integrated into it may be unscrewed or removed from a corresponding pipe section and connected to a separate pipe section at a different location.

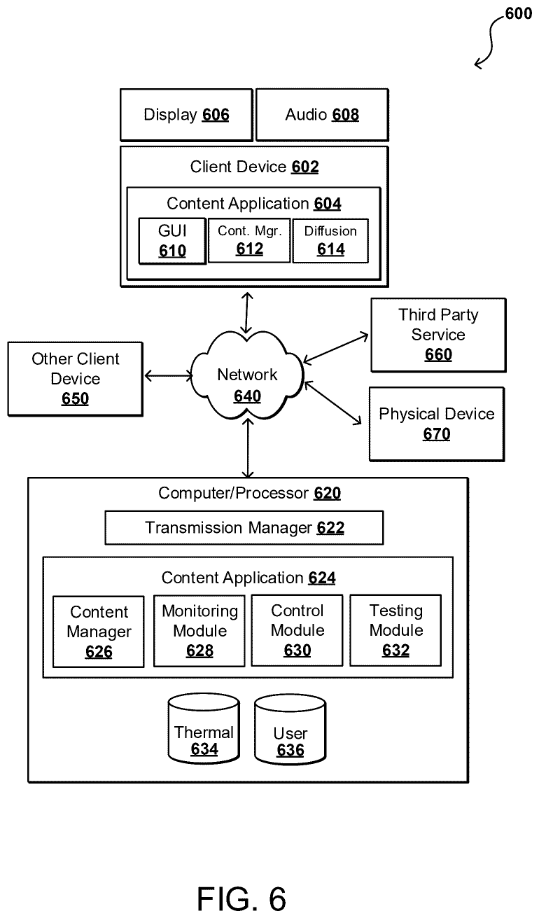

FIG. 6 illustrates an example network configuration 600 of components that may be used to implement aspects of various embodiments, such as to provide, generate, modify, encode, process, fuse, and/or transmit generated image data, calculated measurements, or other such content. In at least one embodiment, a client device 602 may generate or receive data for a session using components of a content application 604 on the client device 602 and data stored locally on that client device. In at least one embodiment, a content application 624 executing on a computer or processor 620 (e.g., a cloud server or control system) may initiate a session associated with at least one client device 602 (e.g., a vehicle or robot), as may use a session manager and user data stored in a user database 636, and may cause content such as liquid coolant or server thermal data to be selected and/or retrieved from a repository 634 to be used by a testing module 632 to calculate one or more performance metrics for a monitoring module 628, which may provide flow data or thermal data to a control module 630 to control a flow or temperature, in an environment where the data is to be used to determine appropriate operation. A content manager 626 may work with at least these various modules to perform testing and analysis, and potentially instruct any actions to be taken in response to a performance metric failing to satisfy an operational requirement. At least a portion of this data or instructional content may be transmitted to the client device 602 and/or a physical device 670 using an appropriate transmission manager 622 to send by download, streaming, or another such transmission channel. An encoder may be used to encode and/or compress at least some of this data before transmitting to the client device 602. In at least one embodiment, the client device 602 receiving such content may provide this content to a corresponding content application 604, which may also or alternatively include a graphical user interface 610, a flow monitor module 612, and a control module 614 for use in providing, synthesizing, rendering, compositing, modifying, or using content for presentation, navigation, control, (or other purposes) on or by the client device 602, such as may be transmitted to the physical device 670. In some embodiments, the computer or processor 620 and client device 602 may be able to communicate directly without needing to transmit data over a network 640, in order to avoid issues with latency and availability, etc. A decoder may also be used to decode data received over the network 640 for presentation via client device 602, such as imaging content or performance metrics through a display device 606 and audio, such as corresponding sounds or synthesized speech, through at least one audio playback device 608, such as speakers or headphones. In at least one embodiment, at least some of this content may already be stored on, rendered on, or accessible to client device 602 such that transmission over a network 640 is not required for at least that portion of content, such as where that content (e.g., thermal data) may have been previously downloaded or stored locally on a hard drive or optical disk. In at least one embodiment, a transmission mechanism such as data streaming may be used to transfer this content from the computer or processor 620, or user database 636, to the client device 602. In at least one embodiment, at least a portion of this content may be obtained, enhanced, and/or streamed from another source, such as a third party service 660 or other client device 650, that may also include a content application for generating, updating, enhancing, or providing map content. In at least one embodiment, portions of this functionality may be performed using multiple computing devices, or multiple processors within one or more computing devices, such as may include a combination of CPUs and GPUs (Graphics Processing Unit), (DPUs), (QPUs), a plurality of parallel processing units (PPUs).

In this example, these client devices may include any appropriate computing devices, as may include a desktop computer, notebook computer, set-top box, streaming device, gaming console, smartphone, tablet computer, VR headset, AR goggles, wearable computer, or a smart television. Each client device may submit a request across at least one wired or wireless network, as may include the Internet, an Ethernet, a local area network (LAN), or a cellular network, among other such options. In this example, these requests may be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency may be reduced by enabling the client devices to interact with servers that are in closer proximity, while also improving security of resources in the cloud provider environment.

In at least one embodiment, such a system may be used for performing graphical rendering operations. In other embodiments, such a system may be used for other purposes, such as for providing image or video content to test or validate autonomous machine applications, or for performing deep learning operations. In at least one embodiment, such a system may be implemented using an edge device, or may incorporate one or more Virtual Machines (VMs). In at least one embodiment, such a system may be implemented at least partially in a data center or at least partially using cloud computing resources.

### Data Center

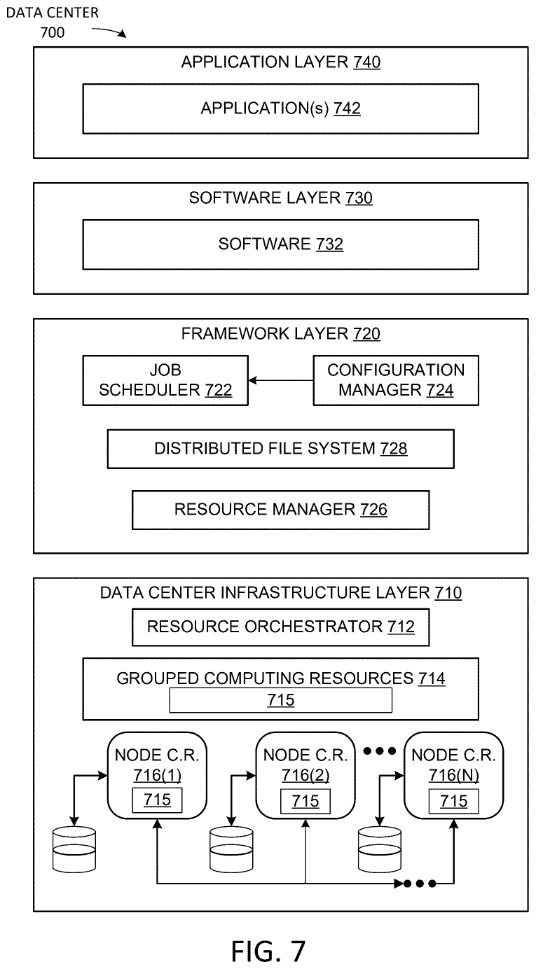

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, a data center may use CPUs, application-specific integrated circuits (ASICs), GPUs, FPGAs, DPUs, QPUs, a plurality of parallel processing units (PPUs), or other hardware to perform training and/or inferencing using above-described resources. Moreover, one or more software and/or hardware resources described above may be configured as a service to allow users to train or perform inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components may be used in data centers that use capillary apparatuses as described herein.

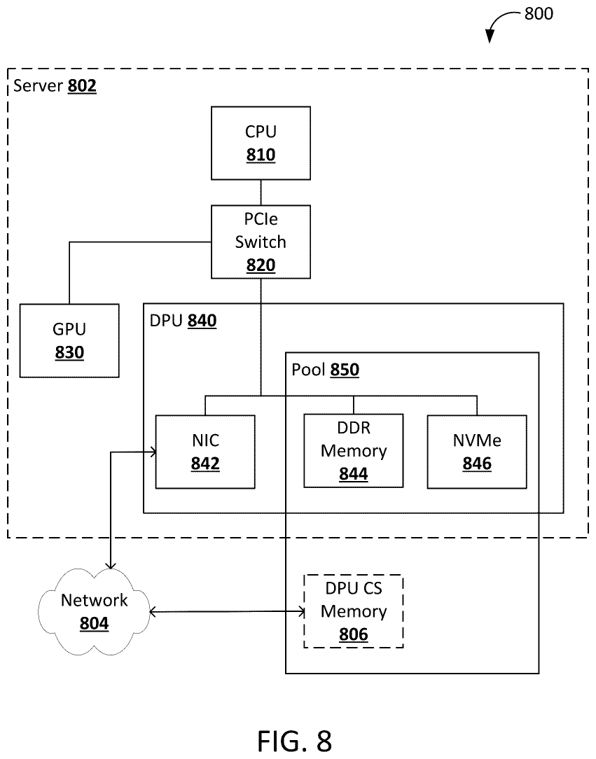

FIG. 8 illustrates an example computing environment 800 in which forward pass offloading to available memory may be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 800 may include a server 802 which may be used to perform HPC workloads, such as AI training or machine learning model training. In an embodiment, the server 802 may be an application instance or a compute node. The server 802 may include a CPU 810 associated with a switch 820, such as a peripheral component interconnect express (PCIe) switch, which may control at least some data transmission over communication paths interconnecting various components. In an embodiment, the CPU 810 may include a root complex processor.

The PCIe switch 820 may also be associated with a GPU 830 and a DPU 840, and may transmit data between at least some of the CPU 810, the GPU 830, the DPU 840, and other components. In an embodiment, the PCIe switch 820 may be associated with more than one GPU or more than one DPU. In another embodiment, the PCIe switch 820 may be located within the DPU 840. The PCIe switch 820 may manage the transfer of at least some data between the CPU 810, the GPU 830, and the DPU 840. In another embodiment, the number of GPUs associated with the PCIe switch 820 may be equal to the number of DPUs associated with the PCIe switch 820. In at least one embodiment, the server 802 may include, without limitation, any number of the CPUs 810, the PCIe switches 820, the GPUs 830, and/or the DPUs 840, in any combination. For example, in at least one embodiment, server 802 could include eight, sixteen, thirty-two, and/or more GPUs 830. In at least one embodiment, communication paths interconnecting various components, including but not limited to the CPU 810, the PCIe switch 820, the GPU 830, and the DPU 840, in FIG. 8 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 840 may include a network interface controller (NIC) 842, a DDR memory 844, and a non-volatile memory express (NVMe) device 846. The NIC 842 may be able to interface with a network 804, which may also interface with additional NVMe devices available to the DPU 840, such as over fabric. In an embodiment, the DPU 840 may not include the NVMe device 846. In another embodiment, the NVMe device 846 may be located on the server 802 and not on the DPU 840. In yet another embodiment, the computing environment 800 may include more than one of the NVMe device 846, such as a first NVMe device in the DPU 840 and a second first NVMe device on the server 802, and associated directly with the PCIe switch 820. In an embodiment, the DPU 840 may not include the DDR memory 844 and may include a computational storage services (CSS) in place of, or in addition to, the DDR memory 844. For example, computing environment 800 may include DPU computational storage (CS) memory 806 available to the DPU 840 as part of the CSS. The network 804 may be able to interface with the DPU CS memory 806 through the NIC 842, according to any suitable interface protocol, such as remote direct memory access (RDMA) over Ethernet, InfiniBand, Fiber Channel, etc.

The total memory of the computing environment 800 available for data storage may be expanded through the use of the DPU 840 on nodes of the system. The DPU 840 may have access to a pool 850 of memory already available to the server 802, such as double data rate (DDR) memory, on-board NVMe devices, NVMe devices over fabric, and CS. The pool 850 of memory may include at least one of the DDR memory 844, NVMe 846, and the DPU CS memory 806. The DPU 840 may also be able to access the available memory of other DPUs as part of the pool 850, and other DPUs may be able to access the available memory of DPU 840, such as the pool 850. This available memory may be accessed and utilized for data storage, without the addition of compute resources, such as compute nodes, which would be required using other solutions. The available pool 850 accessible to the DPU 840 may be provisioned for the server 802 to expand the total memory available for data storage, such as to reduce the data storage load on the CPU 810 or the GPU 830, which may instead increase the utilization of their memory for processing. For example, during training of an AI, the model states, residual states, activation functions, and checkpoints may be stored, or offloaded, on the pool 850 accessible to the DPU 840.

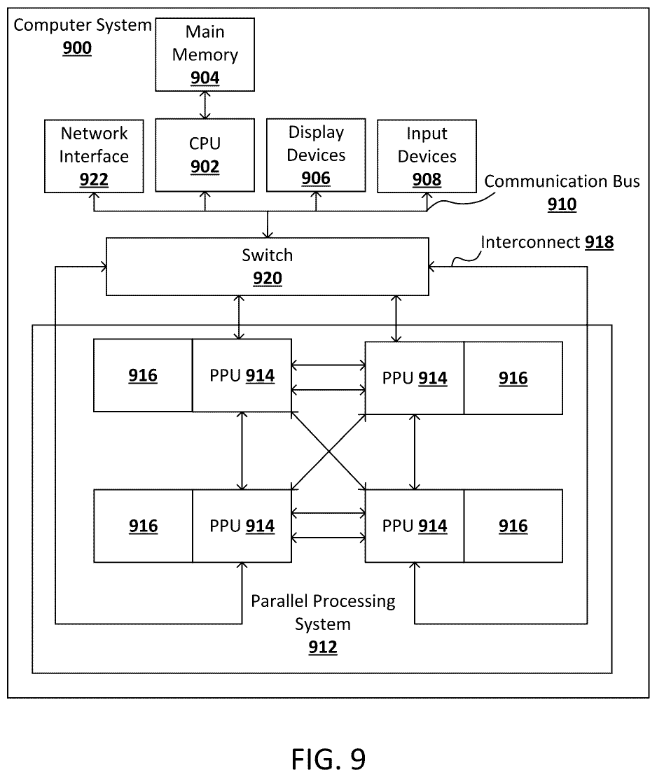

FIG. 9 illustrates a computer system 900, according to at least one embodiment. In at least one embodiment, computer system 900 is configured to implement various processes and methods described throughout this disclosure.

In at least one embodiment, computer system 900 comprises, without limitation, at least one central processing unit (“CPU”) 902 that is connected to a communication bus 910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 900 includes, without limitation, a main memory 904 and control logic (e.g., implemented as hardware, software, or a combination thereof) and data are stored in main memory 904 which may take form of random access memory (“RAM”). In at least one embodiment, a network interface subsystem (“network interface”) 922 provides an interface to other computing devices and networks for receiving data from and transmitting data to other systems from computer system 900.

In at least one embodiment, computer system 900, in at least one embodiment, includes, without limitation, input devices 908, parallel processing system 912, and display devices 906 which may be implemented using a conventional cathode ray tube (“CRT”), liquid crystal display (“LCD”), light emitting diode (“LED”), plasma display, or other suitable display technologies. In at least one embodiment, user input is received from input devices 908 such as keyboard, mouse, touchpad, microphone, and more. In at least one embodiment, each of the foregoing modules may be situated on a single semiconductor platform to form a processing system.

In at least one embodiment, computer programs in form of machine-readable executable code or computer control logic algorithms are stored in main memory 904 and/or secondary storage. Computer programs, if executed by one or more processors, enable system 900 to perform various functions in accordance with at least one embodiment. Memory 904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 902; parallel processing system 912; an integrated circuit capable of at least a portion of capabilities of both CPU 902; parallel processing system 912; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 900 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 912 includes, without limitation, a plurality of parallel processing units (“PPUs”) 914 and associated memories 916. In at least one embodiment, PPUs 914 are connected to a host processor or other peripheral devices via an interconnect 918 and a switch 920 or multiplexer. In at least one embodiment, parallel processing system 912 distributes computational tasks across PPUs 914 which may be parallelizable—for example, as part of distribution of computational tasks across multiple graphics processing unit (“GPU”) thread blocks. In at least one embodiment, memory is shared and accessible (e.g., for read and/or write access) across some or all of PPUs 914, although such shared memory may incur performance penalties relative to use of local memory and registers resident to a PPU 914. In at least one embodiment, operation of PPUs 914 is synchronized through use of a command such as_syncthreads( ), wherein all threads in a block (e.g., executed across multiple PPUs 914) to reach a certain point of execution of code before proceeding.

Such components may be used in data centers that use capillary apparatuses as described herein.

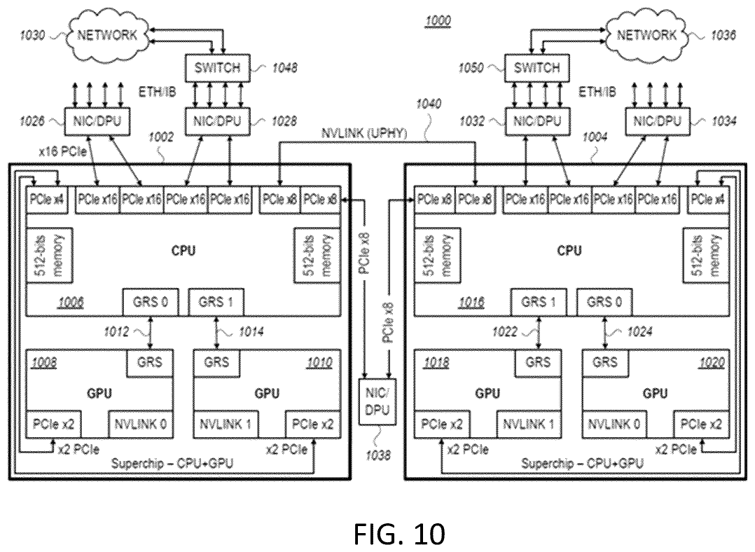

FIG. 10 is a block diagram that schematically illustrates a computing system 1000, e.g., a data center or a High-Performance Computing (HPC) cluster, in accordance with an embodiment that is described herein. System 1000 comprises a plurality of subsystems, e.g., multiple processing devices coupled to each other, multiple network devices, and multiple networks, according to at least one embodiment. Computing system 1000 is designed with multiple integrated circuits (referred to as processing devices), where each integrated circuit may include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high-bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 may include one or more CPUs and one or more GPUs.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 may be coupled to GPU 1008 via a die-to-die (D2D) or chip-to-chip (C2C) interconnect 1012, such as a Ground-Referenced Signaling interconnect (GRS interconnect). CPU 1006 may be coupled to GPU 1010 via a D2D or C2C interconnect 1014. CPU 1006 may also couple to GPU 1008 and GPU 1010 via PCIe interconnects.

CPU 1006 may be coupled to one or more NICs or DPUs, which are coupled to one or more networks. For example, as illustrated in FIG. 10, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 may be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 may be coupled to GPU 1018 via a D2D or C2C interconnect 1022. CPU 1016 may be coupled to GPU 1020 via a D2D or C2C interconnect 1024. CPU 1016 may also couple to GPU 1018 and GPU 1020 via PCIe interconnects. CPU 1016 may be coupled to one or more NICs or DPUs, which are coupled to one or more networks. For example, as illustrated in FIG. 10, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 may be coupled to network 1036 over Ethernet (ETH), NVLINK or InfiniBand (IB) connections.

In at least one embodiment, processing device 1002 and processing device 1004 may communicate with each other via a NIC/DPU 1038, such as over PCIe interconnects. Processing device 1002 and processing device 1004 may also communicate with each other over a high-bandwidth communication interconnects 1040, such as an NVLink interconnect or other high-speed interconnects. The packet switches in FIG. 10 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034 and 1038, and/or any of switches 1048 and 1050, may use ILI packets in accordance with the techniques described herein. Such components may be used in data centers that use capillary apparatuses as described herein.

In example embodiments, the heat-generating element may be a silicon photonics element (e.g., SiPh die) or photonic IC. The elements may be Co-packaged forming a multichip-module (MCM) assembly.

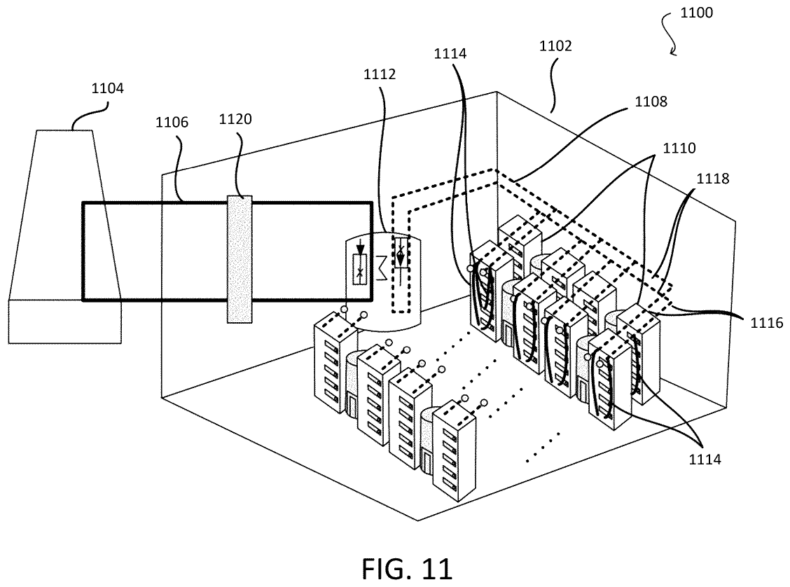

FIG. 11 is a block diagram of an example datacenter 1100 having a cooling system subject to improvements described in at least one embodiment. The datacenter 1100 may be one or more rooms 1102 having racks 1110 and auxiliary equipment to house one or more servers on one or more server trays. The datacenter 1100 is supported by a cooling tower 1104 located external to the datacenter 1100. The cooling tower 1104 dissipates heat from within the datacenter 1100 by acting on a primary cooling loop 1106. Further, a cooling distribution unit (CDU) 1112 is used between the primary cooling loop 1106 and a second or secondary cooling loop 1108 to enable extraction of the heat from the second or secondary cooling loop 1108 to the primary cooling loop 1106. The secondary cooling loop 1108 can access various plumbing all the way into the server tray as required, in an aspect. The loops 1106, 1108 are illustrated as line drawings, but a person of ordinary skill would recognize that one or more plumbing features may be used. In an instance, flexible polyvinyl chloride (PVC) pipes may be used along with associated plumbing to move the fluid along in each of the loops 1106, 1108. One or more coolant pumps, in at least one embodiment, may be used to maintain pressure differences within the loops 1106, 1108 to enable the movement of the coolant according to temperature sensors in various locations, including in the room, in one or more racks 1110, and/or in server boxes or server trays within the racks 1110.

In at least one embodiment, the coolant in the primary cooling loop 1106 and in the secondary cooling loop 1108 may be at least water and an additive, for instance, glycol or propylene glycol. In operation, each of the primary and the secondary cooling loops has their own coolant. In an aspect, the coolant in the secondary cooling loops may be proprietary to requirements of the components in the server tray or racks 1110. The CDU 1112 is capable of sophisticated control of the coolants, independently or concurrently, in the loops 1106, 1108. For instance, the CDU may be adapted to control the flow rate so that the coolant(s) is appropriately distributed to extract heat generated within the racks 1110. Further, more tubing 1114 is provided from the secondary cooling loop 1108 to enter each server tray and to provide coolant to the electrical and/or computing components. In the present disclosure, the electrical and/or computing components are used interchangeably to refer to the heat-generating components that benefit from the present datacenter cooling system. The tubing 1118 that form part of the secondary cooling loop 1108 may be referred to as room manifolds. Separately, the tubing 1116 extending from tubing 1118 may also be part of the secondary cooling loop 1108 but may be referred to as row manifolds. The tubing 1114 enters the racks as part of the secondary cooling loop 1108 but may be referred to as rack cooling manifold. Further, the tubing 1116 extend to all racks along a row in the datacenter 1100. The plumbing of the secondary cooling loop 1108, including the tubings 1118, 1116, and 1114 may be improved by at least one embodiment of the present disclosure. An optional chiller 1120 may be provided in the primary cooling loop within datacenter 1100 to support cooling before the cooling tower. To the extent additional loops exist in the primary control loop, a person of ordinary skill would recognize reading the present disclosure that the additional loops provide cooling external to the rack and external to the secondary cooling loop; and may be taken together with the primary cooling loop for this disclosure.

In at least one embodiment, in operation, heat generated within server trays of the racks 1110 may be transferred to a coolant exiting the racks 1110 via tubing 1114 of the second cooling loop 1108. Pertinently, second coolant (in the secondary cooling loop 1108) from the CDU 1112, for cooling the racks 1110, moves towards the racks 1110. The second coolant from the CDU 1112 passes from on one side of the room manifold having tubing 1118, to one side of the rack 1110 via the tubing 1116, and through one side of the server tray via tubing 1114. Spent second coolant (or exiting second coolant carrying the heat from the computing components) exits out of another side of the server tray (such as enter left side of the rack and exits right side of the rack for the server tray after looping through the server tray or through components on the server tray). The spent second coolant that exits the server tray or the rack 1110 comes out of different side (such as exiting side) of tubing 1114 and moves to a parallel, but also exiting side of the tubing 1116. From the tubing 1116, the spent second coolant moves in a parallel portion of the tubing 1118 going in the opposite direction than the incoming second coolant (which may also be the renewed second coolant), and towards the CDU 1112.

In at least one embodiment, the spent second coolant exchanges its heat with a primary coolant in the primary cooling loop 1106 via the CDU 1112. The spent second coolant is renewed (such as relatively cooled when compared to the temperature at the spent second coolant stage) and ready to be cycled back to through the second cooling loop 1108 to the computing components. Various flow and temperature control features in the CDU 1112 enable control of the heat exchanged from the spent second coolant or the flow of the second coolant in and out of the CDU 1112. CDU 1112 is also able to control a flow of the primary coolant in primary cooling loop 1106. As there are many flow lines or pipes and may ports, couplers, and adapters between the flow lines or pipes and other components, such as the CDU and cold plates, there are many opportunities for leaks that may lead to damage of the IT infrastructure.

Such components may be used in data centers that use capillary apparatuses as described herein.

Various embodiments may be described by the following clauses:
1. An apparatus to detect a presence of liquid by transporting the liquid by capillary action through a capillary tube to a sensing circuit to generate an electrical signal responsive to the presence of the liquid.
2. The apparatus of clause 1, wherein the apparatus is a flexible wrapping material extending axially along a length of the cooling loop and a length of the inlet.
3. The apparatus of clause 1, wherein the capillary tube is radial around the connection point.
4. The apparatus of claim 1, wherein the apparatus is removably attached to a connection point between a manifold and a quick disconnect (QD) point.
5. The apparatus of clause 1, wherein the capillary tube is parallel to one or more additional capillary tubes in the apparatus.
6. The apparatus of clause 1, the sensing circuit comprises two electrodes to produce an electrical signal in the presence of the liquid, wherein the liquid creates a conductive bridge between the two electrodes.
7. The apparatus of clause 6, wherein the electrical signal comprises an electrical charge proportional to a quantity of the liquid.
8. The apparatus of clause 1, the apparatus comprises a first end and a second end, the one or more capillary tubes extending a length of a body of the apparatus from the first end to the second end, wherein the sensing circuit is proximate either the first end or second end.
9. The apparatus of clause 1, wherein the apparatus is a cylinder comprising a first end and a second end, the capillary tube extending axially along a body of the cylinder.
10. The apparatus of clause 9, wherein the cylinder comprises an interior and an exterior, and the capillary tube extends axially along either the interior or exterior of the cylinder.
11. A method for detecting leaks, comprising
   providing an apparatus comprising a sensing circuit and one or more capillary tubes to transport cooling liquid to the sensing circuit;
   transporting, by capillary action of the capillary tubes, leaked cooling liquid to the sensing circuit;
   generating a signal in response to detecting a presence of the cooling liquid; and
   transmitting the signal to a controller.
12. The method of clause 11, wherein the signal comprises location data indicating a location of a leak.
13. The method of clause 11, wherein the signal further comprises an electrical charge proportional to a quantity of cooling liquid.
14. The method of clause 11, further comprising draining the capillary tubes of liquid after transporting the leaked cooling liquid to the sensing circuit.
15. The method of clause 11, further comprising removably attaching the apparatus to one or more connection points between a cooling loop and an inlet.
16. A system comprising:
   a leak-sensing apparatus comprising:
   a sensing circuit to:
      sense a presence of cooling liquid,
      generate a signal responsive to the presence of the leak, and transmit the signal; and
   one or more capillary tubes to transport the cooling liquid by capillary action to the sensing circuit; and
   a controller to:
      receive the signal, and
      responsive to the signal, generate an alert.
17. The system of clause 16, wherein the leak-sensing apparatus is integrated into a connection point between an inlet and a cooling loop.
18. The system of clause 17, wherein the connection point comprises at least a quick disconnect (QD) point.
19. The system of clause 16, wherein the leak-sensing apparatus is a cylinder comprising a first end and a second end, the one or more capillary tubes extending axially along a body of the cylinder.
20. The system of clause 16, wherein the leak-sensing apparatus is a flexible wrapping material extending axially along a length of a cooling loop and a length of a inlet.
21. The system of clause 20, wherein the flexible wrapping material wraps around a connection point comprising a quick disconnect (QD) point.
22. The system of clause 16, wherein the signal comprises location data indicating a location of a leak and size data proportional to a quantity of the liquid.
23. The system of clause 16, wherein the apparatus further comprises a snap-fit mechanism allowing the apparatus to removably attach to an inlet or cooling loop.
24. The system of clause 16, wherein one or more capillary tubes comprise one or more straw-like tubes.
25. The system of clause 16, wherein the sensing circuit is further to:
   transmit one or more telemetry data to the controller, the telemetry data comprising the presence, duration, and frequency of the leak;
and wherein the controller is further to:
   analyze the telemetry data to predict a likelihood of one or more future leaks.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that may be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU may refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU, DPU, QPU, a plurality of parallel processing units (PPUs). A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system..

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data may be accomplished in a variety of ways such as by receiving data as a parameter of a function call or a call to an application programming interface. In at least one embodiment, processes of obtaining, acquiring, receiving, or inputting analog or digital data may be accomplished by transferring data via a serial or parallel interface. In at least one embodiment, processes of obtaining, acquiring, receiving, or inputting analog or digital data may be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data may be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is

1. An apparatus to detect a presence of liquid by transporting the liquid by capillary action through a capillary tube to a sensing circuit to generate an electrical signal responsive to the presence of the liquid.

2. The apparatus of claim 1, wherein the apparatus is a flexible wrapping material extending axially along a length of a cooling loop and a length of an inlet.

3. The apparatus of claim 1, wherein the capillary tube is radial around a connection point.

4. The apparatus of claim 1, wherein the apparatus is removably attached to a connection point between a manifold and a quick disconnect (QD) point.

5. The apparatus of claim 1, wherein the capillary tube is parallel to one or more additional capillary tubes in the apparatus.

6. The apparatus of claim 1, the sensing circuit comprises two electrodes to produce an electrical signal in the presence of the liquid, wherein the liquid creates a conductive bridge between the two electrodes.

7. The apparatus of claim 6, wherein the electrical signal comprises an electrical charge proportional to a quantity of the liquid.

8. The apparatus of claim 1, the apparatus comprises a first end and a second end, the one or more capillary tubes extending a length of a body of the apparatus from the first end to the second end, wherein the sensing circuit is proximate either the first end or second end.

9. The apparatus of claim 1, wherein the apparatus is a cylinder comprising a first end and a second end, the capillary tube extending axially along a body of the cylinder.

10. The apparatus of claim 9, wherein the cylinder comprises an interior and an exterior, and the capillary tube extends axially along either the interior or exterior of the cylinder.

11. A method for detecting leaks, comprising
providing an apparatus comprising a sensing circuit and one or more capillary tubes to transport cooling liquid to the sensing circuit;
transporting, by capillary action of the capillary tubes, leaked cooling liquid to the sensing circuit;
generating a signal in response to detecting a presence of the cooling liquid; and
transmitting the signal to a controller.

12. The method of claim 11, wherein the signal comprises location data indicating a location of a leak.

13. The method of claim 11, wherein the signal further comprises an electrical charge proportional to a quantity of cooling liquid.

14. The method of claim 11, further comprising draining the capillary tubes of liquid after transporting the leaked cooling liquid to the sensing circuit.

15. The method of claim 11, further comprising removably attaching the apparatus to one or more connection points between a cooling loop and an inlet.

16. A system comprising:
a leak-sensing apparatus comprising:
a sensing circuit to:
sense a presence of cooling liquid,
generate a signal responsive to the presence of the leak, and
transmit the signal; and
one or more capillary tubes to transport the cooling liquid by capillary action to the sensing circuit; and
a controller to:
receive the signal, and
responsive to the signal, generate an alert.

17. The system of claim 16, wherein the leak-sensing apparatus is integrated into a connection point between an inlet and a cooling loop.

18. The system of claim 17, wherein the connection point comprises at least a quick disconnect (QD) point.

19. The system of claim 16, wherein the leak-sensing apparatus is a cylinder comprising a first end and a second end, the one or more capillary tubes extending axially along a body of the cylinder.

20. The system of claim 16, wherein the leak-sensing apparatus is a flexible wrapping material extending axially along a length of a cooling loop and a length of a inlet.

21. The system of claim 20, wherein the flexible wrapping material wraps around a connection point comprising a quick disconnect (QD) point.

22. The system of claim 16, wherein the signal comprises location data indicating a location of a leak and size data proportional to a quantity of the liquid.

23. The system of claim 16, wherein the apparatus further comprises a snap-fit mechanism allowing the apparatus to removably attach to an inlet or cooling loop.

24. The system of claim 16, wherein one or more capillary tubes comprise one or more straw-like tubes.

25. The system of claim 16, wherein the sensing circuit is further to:
transmit one or more telemetry data to the controller, the telemetry data comprising the presence, duration, and frequency of the leak;
and wherein the controller is further to:
analyze the telemetry data to predict a likelihood of one or more future leaks.
